(19) United States
(12) Patent Application Publication
(10) Pub. No.: US 2020/0121116 A1
(43) Pub. Date: Apr. 23, 2020

(54) FILTERING RECEPTACLE AND METHOD OF USING IT

(71) Applicant: FABRIKATORS ApS, Kgs. Lyngby (DK)

(72) Inventors: Lars Forsberg, Kongens Lyngby (DK); Peter Beicker Andersen, Lyngby (DK); Tobias Henius, Copenhagen N (DK)

(21) Appl. No.: 16/625,665

(22) PCT Filed: Jun. 29, 2018
(86) PCT No.: PCT/DK2018/050173

§ 371 Date: Dec. 20, 2019

(30) Foreign Application Priority Data
Jun. 29, 2017 (DK) PA 2017 705 15

(51) Int. Cl. A47J 31/20; A47J 31/46

(52) U.S. Cl. CPC A47J 31/20; A47J 31/52; A47J 31/46

(57) ABSTRACT

A filtering receptacle (1) for a solid flavour base is dimensioned to fit inside a pot (23) of a French press (24). The filtering receptacle (1) has a circumferential central wall part (3) that extends upwards from a bottom wall part (4) and terminates in a free edge (5) of a circumferential upper wall part (2) opposite the bottom wall part (4), which free edge (5) delimits an opening (6) for adding the solid flavour base to the filtering receptacle (1). The circumferential upper wall part (2) has a plurality of through-going drain passages (7), said through-going drain passages (7) are distributed spaced apart along the circumferential upper wall part (2) and are retracted from the free edge (5), at least some of the through-going drain passages (7) of the circumferential upper wall part (2) extend into an associated channel (8) formed in the exterior face (9) of at least the circumferential central wall part (3), wherein a channel (8) extend from its through-going drain passage (7) down towards the bottom wall part (4) along the majority of the circumferential central wall part (3). The filtering receptacle keeps hold of spend flavour base to that said flavour base can be easily discarded separate.

The present invention relates to a filtering receptacle for a solid flavour base, which filtering receptacle is dimensioned to fit inside a pot of a French press, wherein the filtering receptacle has a circumferential central wall part that extends upwards from a bottom wall part and terminates in a free edge of a circumferential upper wall part opposite the bottom wall part, which free edge delimits an opening for adding the solid flavour base to the filtering receptacle.

A solid ground flavour base, such as ground coffee, wherefrom a flavour can be extracted to produce a beverage, is typically placed on the bottom of the brewing chamber of the pot of the French press and hot water is poured onto it. After a selected brewing time, the filter piston is pressed down towards the bottom of the pot to compact the ground solid flavour base and separate the beverage from the solids.

Subsequent cleaning the French press and getting the ground base, e.g. coffee grounds, out of the brewing chamber is a dirty and annoying task. The usual way to clean the French press is first to pull out the filter piston, remove the majority of the coffee grounds using a spoon and/or turning the pot upside down. The residual solid flavour base grounds in the brewing chamber needs to be flushed out or washed off and are spread all over the sink, at the risk of drain blockage.

Due to these disadvantages many people tend not to use their French press and turns to coffee making machines for making coffee despite the coffee made in a French press often taste better than the coffee made by the coffee making machine.

International patent application no. WO2016/112370 discloses a French press with an insert for accommodating a portion of solid flavour base to be extracted for making a beverage. This known insert is designed as a filtering basket having a solid bottom with a bottom perimeter edge, a porous top with a top perimeter edge, a porous basket side that releasable attaches to and extends vertically from either the basket's top or bottom perimeter edges and with the basket side having an upper portion that includes a basket rim. This filtering basket has a special configuration adapted to enable the basket top to attach to the distal end of the filter piston so as to enable the filtering basket to be temporarily situated in the pot and moved vertically up and down within it by the movement of the piston as the beverage in the pot is filtered of grounds. A filter seal is attached to the filter basket's top edge and sealing it to the container wall as the filter basket moves down in the container so as to prevent the solid flavour base from passing between the filter basket side and the pot wall during the movement of the filtering basket and rising above the filtering basket's top surface. A basket coupling means that is attached to the filtering basket has a configuration adapted to enable the basket coupling means to temporarily and releasable lock together with the insert when the bottom of the filtering basket moves downward through the insert's opening and into said insert to compact the solid flavour base. This locking together serve to enable the insert, with its content of now compacted solid flavour base, to be lifted upward and out of the container.

Published US patent application no. Us2012328750 discloses a substantially similar insert for a French press to be inserted into the brewing chamber prior to addition of water and solid flavour base. The bottom of the insert contains multiple drain openings covered by a fine mesh to allow the water to drain. A pivotable handle is attached to opposite pivots protruding inside the insert on the inner perimeter at or near the top opening of said insert. The handle is in a turned-down position when the filter piston is pressed down towards the insert. When the handle is swung upwards it can be grasped and used to remove the insert from the pot. The protruding pivots and handle define an ultimate bottom position for compressing the filter piston. Once the filter piston hits the pivots and the handle it cannot be pressed further down, resulting in that this known apparatus is unsuited for versatile use. E.g. using it with a small amount of solid flavour base that will only partly occupy the space below the pivots and handle is not possible because if the diameter of the filter piston is selected to allow the filter piston to pass by, ground base will rise into the brew above the insert.

Common for both the above discussed inserts is that they need to be pulled up from the pot using a substantial force to overcome the contact force to the surrounding pot wall. Furthermore, additional mechanical coupling means and means for grasping the insert are required present.

The main aspect of the present invention is to provide an easy detachable insert for a French press, in particular providing a filtering receptacle of the kind mentioned in the opening paragraph that requires little or no effort for being taken out of the pot of the French press.

It is yet an aspect of the present invention to provide an insert of the kind mentioned in the opening paragraph that can be taken out of the pot of the French press without using extensive force or additional tools or specially designed and added coupling means.

It is yet an aspect of the present invention to provide an insert of the kind mentioned in the opening paragraph, which is easy to clean.

It is yet an aspect of the present invention to provide an insert of the kind mentioned in the opening paragraph that is re-usable.

The novel and unique whereby these and other aspects are achieved according to the invention consist in that the circumferential upper wall part has a plurality of through-going drain passages, said through-going drain passages are distributed spaced apart along the circumferential upper wall part and are retracted from the free edge, at least some of the through-going drain passages of the circumferential upper wall part extend into an associated channel formed in the exterior face of at least the circumferential central wall part, wherein a channel extend from its through-going drain passage down towards the bottom wall part along the majority of the circumferential central wall part.

Within the context of the present invention the term “solid flavour base” means that the flavour base is either a compressed block of particles of a flavour substance, the particles of a flavour substance are confined inside a porous water- and flavour-permeable packaging approved for use with foods, or just particles of a flavour substance, e.g. ground coffee or tea leaves. However any particulate solid flavoured substance intended for making a flavoured beverage may serve as a “solid flavour base”.

The term “filter piston” for the French press means the plunger device comprising the perforated plunger part, thus the meshed front part, and the plunger rod whereto the perforated plunger part is detachable secured. The perforated plunger part of the filter piston has one or more combined and assembled filter elements and meshes at the end of the plunger rod. The filter piston is reciprocatingly arranged inside the pot of the French press, typically a glass cylinder with a closed bottom and a top opening for entry of the filter piston. The meshed front part of the filter piston includes at least three circular filter components: a spring filter, a micro mesh filter and a base filter. The spring filter is the top filter facing the lid of the French press and the base filter faces the bottom of the pot. The micro mesh filter is inserted between the spring filter and the base filter. The base filter has an upwards facing central screw means that passes through central openings in the micro mesh filter and the spring filter to couple together with the plunger rod and combine the three filter components in close proximity to obtain the fine filtering functionality of the filter piston.

The spring filter is typically made of stainless steel to help keep the plunger safe and straight. The “spring filter” has a perforated plate provided with concentric circles of openings of various sizes. Along the perimeter of the perforated plate of the spring filter a circumferential spring is arranged to keep the filter piston central in the pot. The exterior diameter of the circumferential spring is slightly larger than the interior diameter of the pot in order to exert a pressure on the pot wall. The “micro mesh filter” is the primary filter that keeps the ground coffee below the filter piston during infusion of flavour to the water, in particular when pressing the filter piston down into the pot. The micro mesh filter is thus the filter screen and can be made of e.g. nylon or metal. The micro mesh filter has a larger diameter than the exterior diameter of the spring filter. Furthermore, the micro mesh filter curves slightly upwards along its perimeter with a curvature that corresponds to the curvature of the circumferential spring of the spring filter, to at least partly receive and support said circumferential spring and obtain filtering also along the flexible edge of the spring filter in contact with the pot.

The “base filter” is the base part that serves to keep the three filter components together. The base filter is typically also made of stainless steel, and it is typically a ring with two diametrically crossbars, or similar wheel-like structure.

The term “French press” is a technical term well known in the art of making coffee. Coffee is brewed by placing the ground coffee in the empty pot and adding hot water at about 93-96° C. E.g. 30 g of coffee grounds can be used to 500 ml water, but these amounts is adjusted in accordance with personal taste and in view of particle size. The finer grinding the higher degree of infusion and thus stronger taste of beverage. Thus less flavour base must be used than for course grounds. Brewing time is about two to four minutes. The filter piston with is pressed down into the pot to separate the grounds and hold them at the bottom of the pot. Some mesh filter piston do not compress the coffee grounds, due to short plunger rods leaving a space about 30 mm below the piston in its lowest position. Such a space can expediently be used in the present invention to accommodate the bottom wall part of the filtering receptacle of the present invention but such a space in nevertheless not mandatory as long as the length of the filter piston suffice to reach inside the filtering receptacle when depressed towards the bottom wall of the pot of the French press.

When the filtering receptacle of the present invention is placed at the bottom of the pot of the French press and the filter piston of the French press is moved towards the bottom of the pot in the direction of the filtering receptacle the plurality of through-going drain passages in the circumferential wall allows the water in front of the piston to pass through so that the filtering receptacle does not fold.

The through-going drain passages are distributed spaced apart along the circumferential upper wall part and are retracted from the free edge, which free edge thus define an intact rim adjacent the circumferential pot wall.

Preferably the through-going drain passages are distributed equidistantly. In an even more preferred embodiment the through-going drain passages extends from an interior drain opening at the interior face of the circumferential upper wall part to an exterior opening located at the exterior face of the filtering receptacle at the transition of the circumferential upper wall part and the circumferential central wall part. Preferably the interior opening is closer to the free edge than to the exterior opening, whereby the through-going drain passages are extending in an inclined angle less than 90° in relation to the centre longitudinal axis of the filtering receptacle.

At least some of the through-going drain passages of the circumferential upper wall part extend into an associated channel formed in the exterior side of the circumferential central wall part, and so that such a channel extend from its through-going drain passage along the majority of the circumferential central wall part down towards the bottom wall part to serve as a relief for water being moved towards the filtering receptacle thereby avoiding that the filtering receptacle float upwards in the pot in response to depressing the filter piston. The through-going drain passages with associated drain channels further serve to avoid creation of a negative pressure between the pot wall and the wall parts of the filtering receptacle when the filter piston is used to retract the filtering receptacle from the pot as a combined unit where the filter piston disengagingly engages the filtering receptacle without use of any fastening means, any additional coupling means, and engaging so firmly that the filtering receptacle does not disengage unintentionally prior to the combined unit is drawn fully out of the pot.

The filtering receptacle of the present invention is thus substantially shaped as a cup with through-going drain passages that passes fully through the thickness of the cup wall at the top perimeter and wherein at least some of these through-going drain passages proceed into a respective associated furrow or channel having a closed bottom above the bottom wall part of the filtering receptacle. Preferably the bottom wall part has no perforation, holes or openings, through which the ground flavour base can get out when the filtering receptacle is pulled up the pot.

In an embodiment of the present invention the channels may extends towards the bottom wall part substantially perpendicularly in relation to the free edge, preferably all the through-going drain passages have an associated channel. In this embodiment also the channels can be distributed equidistantly. The channels may be straight or be curved so that the through-going passage is circumferentially offset the opposite end of the associated channel, e.g. between 10-30% offset measured from top to bottom of the length of the channel.

The bottom wall part may have a foot part protruding away from the opening of the filtering receptacle so that the bottom wall part becomes spaced from the bottom of the pot. The foot part may advantageously serve to prevent that a vacuum is created when the filtering receptacle is retracted, which vacuum could cause premature disengagement of filtering receptacle and filter piston if the force needed to overcome the vacuum is larger than the engagement force between the filtering receptacle and the filter piston. The foot part can be designed as a protruding logo, but is not restricted to such design. The foot part can have any design that lifts the bottom wall part free of the interior bottom of the pot.

The filtering receptacle is designed to fit inside the pot so as to be positioned at the interior bottom of said pot. For example an interior diameter of the filtering receptacle can be larger at the upper wall part than at the smallest interior diameter of at least at the circumferential upper wall part. The larger inter diameter of the upper wall part can e.g. be provided by an outmost flaring of the wall part. Preferably the interior diameter of the filtering receptacle can decrease from the upper wall part towards the circumferential upper wall part, e.g. in a gradual manner towards the centre of the circumferential upper wall part and increase again towards the bottom wall part so that the filtering receptacle has an hour glass shape, thus provides for better hold at the filter piston the deeper inside the circumferential upper wall part of the filtering receptacle the filter piston is pressed for engagement for the purpose of retracting the combined unit of the filtering receptacle and the filter piston. Emphasis is made the interior diameter of the upper wall part of the filtering receptacle may be the same or slightly smaller than the meshed front part of the filter piston. The circumferential spring of the spring filter posses a resiliency that allows the filter piston to be moved further down inside the filtering receptacle to engage said the filtering receptacle when needed for retracting the filtering receptacle despite the filtering receptacle has a smaller interior diameter than the exterior diameter of the meshed front part of the filter piston.

The tapering from the upper wall part to the middle section of the circumferential central wall part can e.g. be from 0.5°-10°, optionally between 1°-5°, optionally between 2°-4°. The tapering from the bottom wall part to the middle section of the circumferential central wall part can within similar range. The exterior diameter of the upper wall part and the lower wall part of the filtering receptacle can as an example be between 0.2% and 5% smaller than the interior diameter of the pot of the French press, and the middle section of the circumferential central wall part be even smaller.

The bottom wall part may have an inverted centre section whereby at least some of the bottom wall part is free of the interior bottom of the pot to further avoid that the filtering receptacle acts as a suction cup when attempting to retract it from the pot. Optionally the foot part is at least partly located at and protruding from the inverted centre section.

The piston is left inside the pot when the flavour base has been infused by very hot water and until the brew has been poured from the pot. During this holding time the temperature of the brew and of the pot and filtering receptacle drops. It may thus be preferred that the filtering receptacle is made of a material that expands when subjected to at temperature range between 80° C. and 100° C. and retracts again when cooled below 50° C. so that the filtering receptacle inherently shrinks and engagement of the meshed front part of the filter piston gets strong.

A suitable material for the filtering receptacle is e.g. a plastic material approved for use with foods. A material such as poly propylene, rubber, silicon or any other similar and durable material that is sufficient to operate under the conditions described above will be suitable, and the preferred materials are the ones being able to provide for heat-induced expansion and relaxation in response to cooling.

The filtering receptacle according to the present invention is particularly suited for use with the solid flavour bases ground coffee or tealeaves.

It should be noted that although the filtering receptacle is described above in relation to use in a French press, such a filtering receptacle can be used in any cylindrical container equipped with a meshed front part on a plunger rod, which can constitute a filter piston.

The present invention also relates to a method of operating the filtering receptacle described above in a French press to make a flavoured beverage, such as coffee, by infusion of a solid flavour base, such as ground coffee.

The method comprises the steps of
a) placing the filtering receptacle at a bottom of a pot of the French press,
b) adding the solid flavour base to the filtering receptacle, before or after step a),
c) adding hot water to the pot,
d) allowing the flavour of the solid flavour base to infuse the hot water,
e) depressing a filter piston of the French press down towards the filtering receptacle to separate the brewed beverage from the solid flavour base,
f) pouring the beverage from the French press while the filter piston remains situated above or engaged to the filtering receptacle,
g) allowing the filtering receptacle to cool if not already cooled,
h) optionally pressing the filter piston in engagement with the filtering receptacle if not already engaged,
i) retracting the engaged filter piston and filtering receptacle out of the pot as a combined unit, and
j) disengaging the filter piston and filtering receptacle.

The disengaging of the meshed front part, thus the combined spring filter, micro mesh filter, and base filter of the filter piston, from the filtering receptacle so that the filtering receptacle can be emptied of ground flavour base, cleaned and reused, can simply be done by e.g. a rotation, a twisting or any similar movement of the meshed front part in relation to the filtering receptacle, or by a combination of such movement. When performing such a movement the circumferential spring of the spring filter yield easily due to its resiliency and the filtering receptacle come free. Very little effort and force needs to be done to disengage the filter piston from the filtering receptacle. The filtering receptacle does not gets accidentally free during retracting it from the pot, partly because the circumferential spring presses the circumferential wall toward the pot wall and partly because the filtering receptacle has a smaller diameter than the meshed front part, at least when at a temperature below 50°, optionally at any temperature.

The filtering receptacle and French press can then be cleaned. So the filtering receptacle and not the pot is emptied of spent ground coffee, which is directly put into the garbage bin. Only little ground coffee remains on the filtering receptacle and if can be rinsed under tap water and put in the dishwasher without any substantial further cleaning. Since all ground coffee is collected inside the pot of the French press itself is free of ground coffee and goes directly into the dishwasher or other kind of cleaning. Residues of ground coffee on the filter piston and inside the filtering receptacle are minimal and drain blockage is no longer a problem.

The invention will now be described with references to the drawing in which

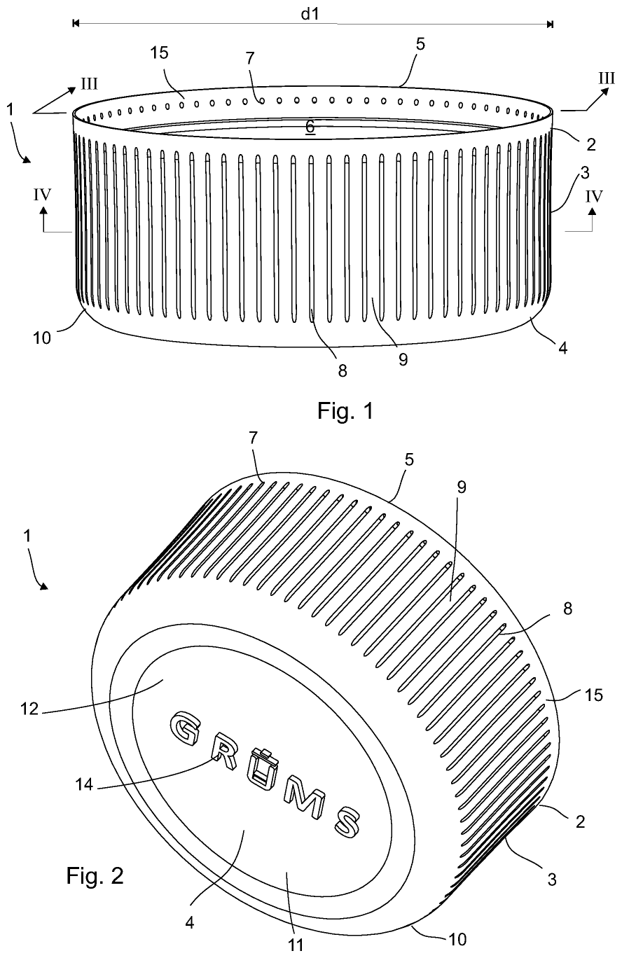

FIG. 1 is a perspective view of the filtering receptacle seen from the side,

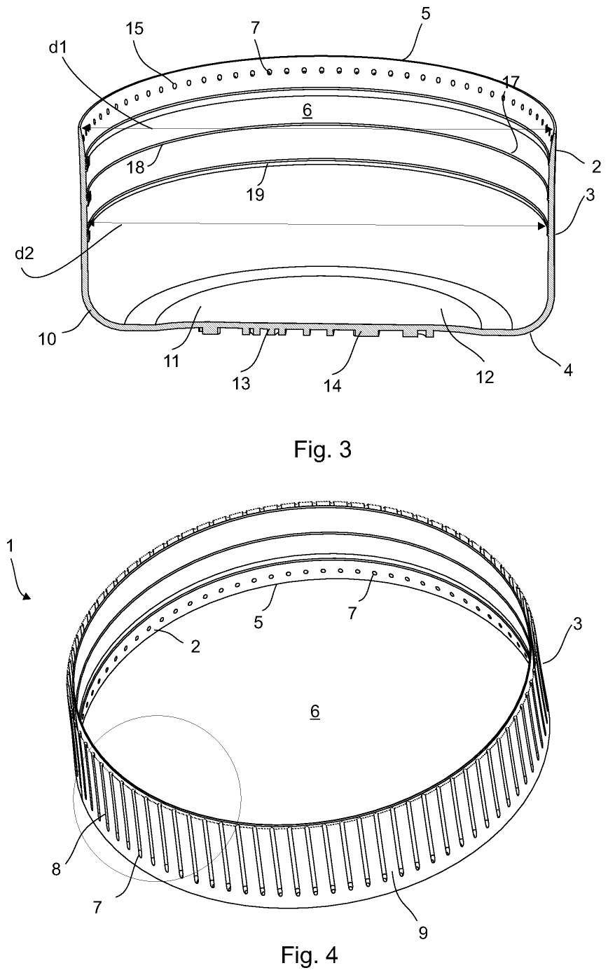

FIG. 2 is a perspective view of the filtering receptacle seen from the exterior face of the bottom wall part,

FIG. 3 is a sectional view taken along line III-III in FIG. 1,

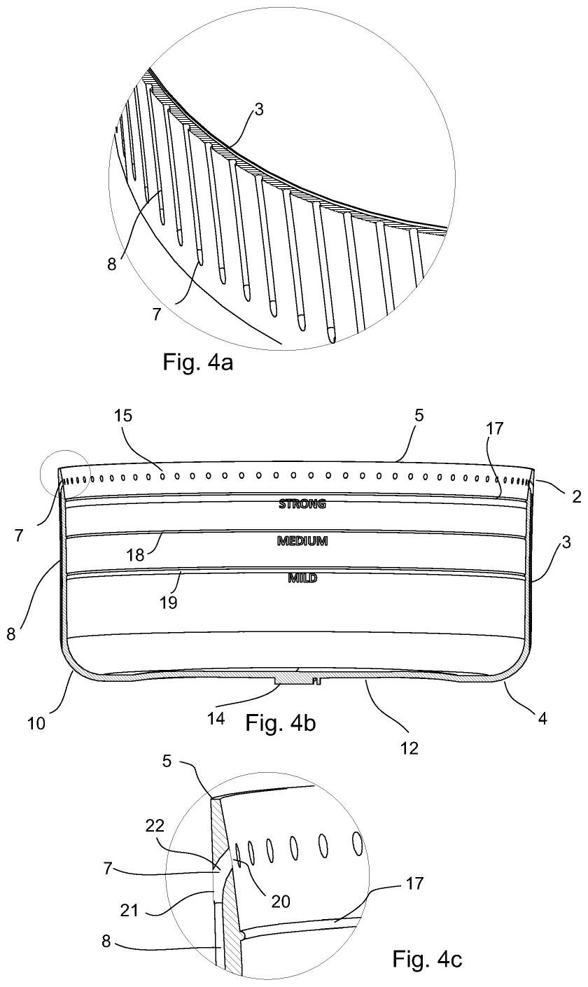

FIG. 4 is a sectional view taken along line IV-IV in FIG. 1,

FIG. 4a is an enlarged scale view of the encircled detail in FIG. 4 in cross-sectional view taken along line IV-IV in FIG. 1,

FIG. 4b is sectional view of FIG. 1 taken at the location of a through-going drain passage,

FIG. 4c is an enlarged scale view of the encircled detail in FIG. 4b,

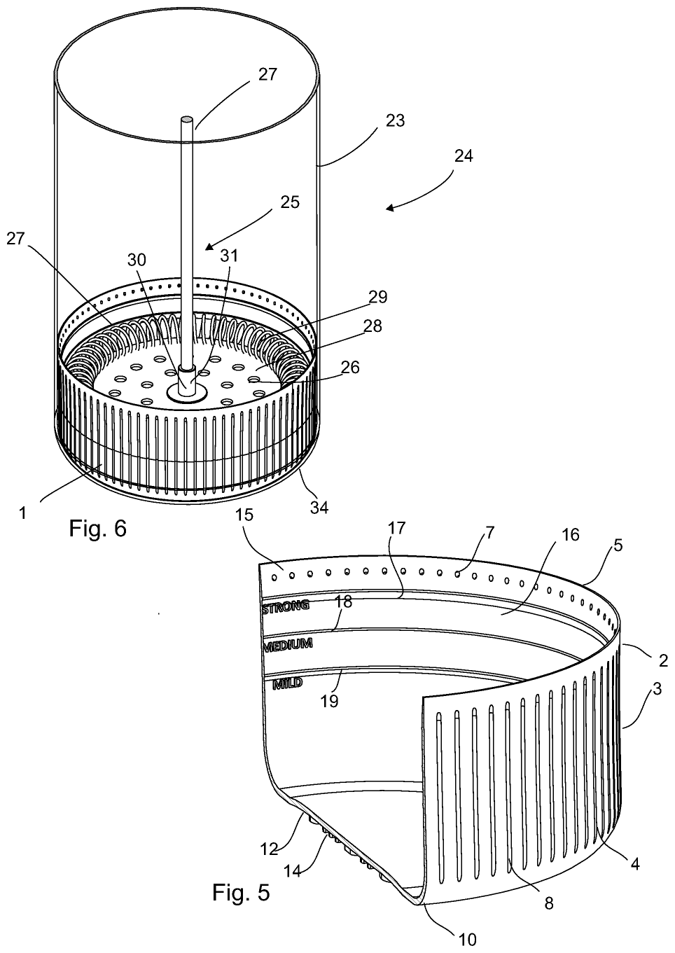

FIG. 5 is a perspective view of a fragment of a French press with a filtering receptacle,

FIG. 6 is a sectional perspective view inside the filtering receptacle seen in FIG. 1, and

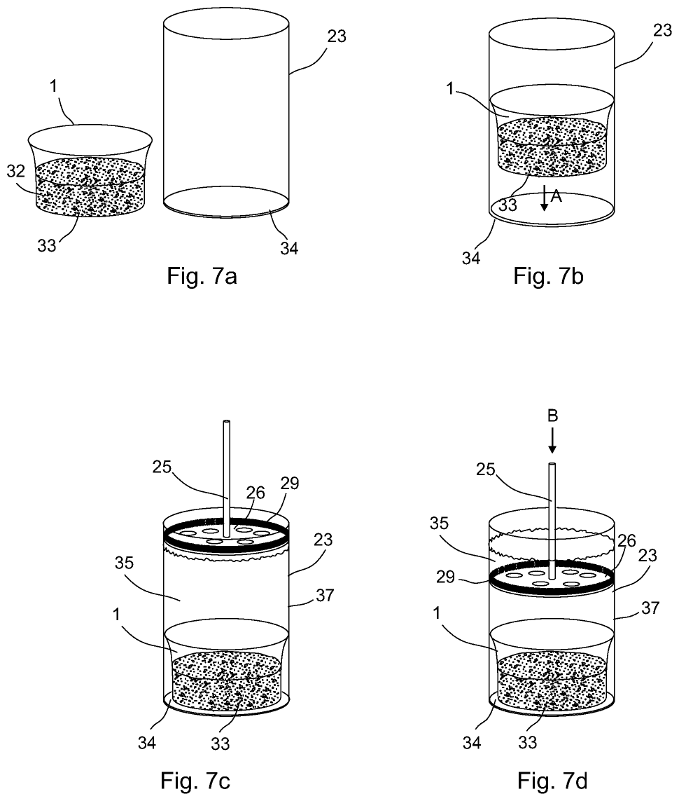

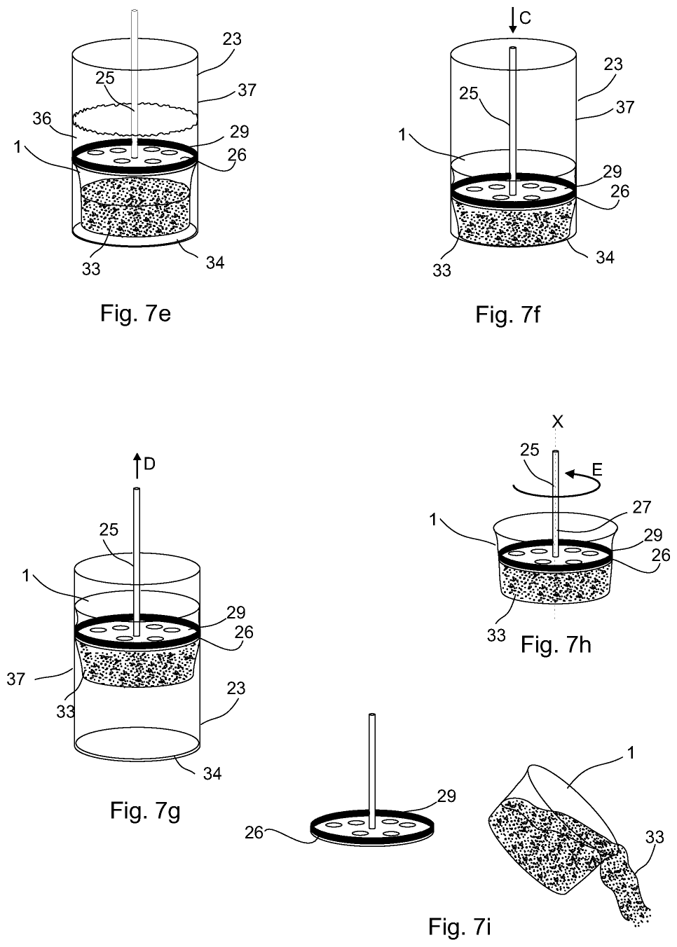

FIGS. 7a-7i illustrate schematically the method of using the filtering receptacle to produce a beverage from a flavour base placed in the filtering receptacle located in a French press, and the operation of the receptacle together with the filter piston of said French press.

The filtering receptacle 1 seen in FIG. 1 has a circumferential upper wall part 2 that extends via a circumferential central wall part 3 into a bottom wall part 4.

The filtering receptacle 1 is thus shaped as a cup with a free edge 5 defining the outer perimeter of the circumferential upper wall part 2 and having an opening 6 with and interior diameter d1.

The circumferential upper wall part 2 has a plurality of through-going drain passages 7, which in the present example are distributed equidistantly spaced apart along said circumferential upper wall part 2 and are retracted from the free edge 5. Each of the through-going drain passages of the circumferential upper wall part 2 extend into an associated channel 8 formed in the exterior side 9 of the circumferential central wall part 3, wherein a channel 8 extends perpendicular to the free edge 5 from its through-going drain passage 7 down along the exterior side of circumferential central wall part 3 to the bottom wall part 4.

As seen best in the sectional views of FIG. 4, FIG. 4a, FIG. 4b and FIG. 4c, in the present embodiment the channels 8 have intact bottoms and are without perforations that could create open access for any fluid transmission from chamber of the filtering receptacle to the outside of the filtering receptacle. The channels 8 curve slightly along the sloping wall at the transition 10 between the circumferential central wall part 3 and the bottom wall part 4. The channels follow the curvature of the exterior face of the circumferential central wall part 3, which in the present embodiment is slightly constricted at the middle section. Thus for the present embodiment of a filtering receptacle 1, the bottom wall part and upper wall part may have substantial same largest exterior diameters and the exterior diameter of the middle section be smaller, so that a gap is created to the pot wall, as seen in FIG. 5.

As seen in FIGS. 2 and 3 the bottom wall part 4 has a slightly inverted centre section 12 protruding upwards towards the opening 6. A foot part 13 in the form of the GRUMS logo 14 is protruding from an exterior surface 11 of the inverted centre section 12.

As seen best in FIG. 3 the wall thickness of the circumferential upper wall part 2 tapers as a flared lip 15 towards its free edge 5. The interior diameter d2 at the middle of the circumferential central wall part 3 is smaller than the interior diameter d1 at the free edge 5. The flared lip 15 of the free edge 5 of the upper wall part 2 can have an increased exterior diameter of 1-10%, preferably 5-8% compared to the interior diameter of the upper wall part 2, as well as being increased by 5-10% of the interior diameter d2 at the middle of the circumferential central wall part 3.

As seen in the enlarged detailed view of FIG. 4c the inlet opening 20 of the through-going drain passage 7 starts closer to the free edge 4 than the outlet opening 21 of the through-going drain passage 7. Thus the flow passage 22 of the through-going drain passage 7 turns towards the bottom wall at its exit into the channel 8.

As seen in FIG. 5 the interior face 16 of the filtering receptacle 1 has three inwards protruding brewing ribs 16, 17, 18 with respective indications STRONG, MEDIUM, and MILD integrally molded and protruding. If the brewer wishes a strong coffee flavour the filtering receptacle is filled with ground coffee to the first rib 17 and after infusion of the ground coffee the filter piston is depressed until the first position where it contacts the first rib 17, indicating STRONG. When the pot is emptied, e.g. when the coffee infusion is drunk, the filter piston is forced further down into the filtering receptacle towards the bottom wall part 4 to obtain firm engagement in order to safely retract the filtering receptacle 1 with its content of compacted wet ground coffee.

Similarly, if the brewer wishes a medium coffee flavour the filtering receptacle is filled with ground coffee to the second rib 18. After infusion of the ground coffee, the filter piston is depressed until the second position where it contacts the second rib 18, indicating MEDIUM.

If the brewer only wishes a mild coffee flavour the filtering receptacle is only filled with ground coffee to the third rib 19. After infusion the filter piston is depressed until it is in the third position where it contacts the third rib 19, indicating MILD.

At the respective first position, second position and third position contact between ground coffee and hot water has been disrupted to the extent possible so that infusion substantially stops.

The molded indications STRONG, MEDIUM and MILD are not mandatory but preferred. The ribs further provide a tactile guidance to the user to stop depression temporarily until the pot is empty of brew and the filter piston is about to be retracted.

In FIG. 6 the filtering receptacle 1 has been inserted into the pot 23 of an empty French press 24, Only the lower part of the pot 23 and of the filter piston 25 with the meshed front part 26 mounted on the plunger rod 27 is seen in FIG. 6 The meshed front part 26 of the filter piston 25 is depressed below the first rib 17.

The meshed front part 26 of the filter piston 25 consists of a base filter (not visual in FIG. 6, a micro mesh filter 27, and a spring filter 28. The spring filter 28 has a circumferential spring 29, and the base filter has an upwards male screw means 30 secured inside a female screw means 31 at the distal end of the plunger rod 27.

FIGS. 7a-7j illustrate schematically the various steps of the method of using the filtering receptacle 1 in accordance with the present invention.

FIG. 7a shows schematically step b). The filtering receptacle 1 has been filled with flavour base 32, in the present example ground coffee 33 to level MEDIUM. The pot 23 is made ready for brewing coffee.

FIG. 7b shows step a) wherein the flavour-base-filled filtering receptacle 1 is placed in the pot 23 and allowed to sink to the bottom 34 of the pot 23, as indicated by arrow A.

In the situation shown in FIG. 7c the method has reached steps c) and d) in that water 35 has been added to the pot 23 to extract the flavour of the flavour base by infusion, thus extract the coffee flavour to make coffee, Extraction time is e.g. 3-7 minutes depending on type of coffee, and how strong the coffee should be. The filter piston 25 is arranged at the top of the pot 23, substantially at the water level, and the circumferential spring 29 resiliently engages the pot wall 37. For the purpose of illustrating the method of the present invention, the meshed front part 26 is shown schematically without the many perforations and through-going opening that allows the water 35 to pass through while keeping the ground coffee below it.

FIG. 7d illustrates step e) in which the filter piston 25 has is being pushed down towards the filtering receptacle 1, as indicated by arrow B, to separate the brewed beverage 36, the coffee, from the solid flavour base 32, the ground coffee 33.

In the situation shown in FIG. 7e, step f) has been performed partly. Thus some of the brewed coffee 36 has been poured from the pot 23, while the filter piston 25 remains situated above the filtering receptacle 1. When all the coffee 36 has been poured from the pot 1 the temperature of the filtering receptacle 1 has dropped, in accordance with step g) and in accordance with the explanation of temperature drop stated above.

Now, as illustrated in FIG. 7f, step h) is performed. In step h) the meshed front part 26 of the filter piston 25 has been pressed, as indicated by arrow C, down into the filtering receptacle 1 to obtain firm engagement and coupling to said filtering receptacle 1, so that when the upwards translatory movement of step i), which is indicated by arrow D in FIG. 7g, is performed, the filtering receptacle 1 and the meshed front part 26 does not disengage due to the spring force of the circumferential spring 29 of the spring filter that acts on opposite circumferential wall 2, 3, 4 of the filtering receptacle, e.g. on the upper circumferential wall part 2 or on the central circumferential wall part 3 depending on the filling level of the filtering receptacle 1 and on the extent to which the meshed front part 26 has been moved down into the filtering receptacle 1. The filtering receptacle 1 comes along easily up the pot 23 due to the resiliency of the circumferential spring 29. Due to the same force, and optionally any potential inherent shrinkage of the filtering receptacle 1 back to its start configuration before hot water was added, contributes to the firm engagement during pulling the filtering receptacle 1 up the pot 23 by means of the filter piston 25.

FIG. 7h illustrates that in step j) a simple rotation about the central axis of the plunger rod, as indicated by arrow E, may suffice to disengage the filled filtering receptacle 1 from the filter piston 25. Optionally also a twisting or tilting movement can be used in addition or exclusively for that purpose. If twisting or tilting is used, e.g. during the rotation the plunger rod 27, said plunger rod 27 is simply tilted slightly in relation to the central axis X of the filter piston.

In step k) shown in FIG. 7i, the filter piston 25 and the filtering receptacle have been separated and the spent coffee ground is being disposed.

Thus to summarise, the meshed front part 26 of the filter piston 25 will after the coffee grounds has saturated just with a gentle push towards the filtering receptacle 1 locate into said filtering receptacle 1. Once situated into the filtering receptacle 1 for the retraction of same, said filtering receptacle 1 will, due to the now embedded circumferential spring 29 of the spring filter 28 of the filter piston 25, connect the filtering receptacle 1 and the filter piston 25 by way of a frictional force exerted by a.o. said circumferential spring 29. The frictional force and the spring force will all together at all times exceed the downward gravitational force acting on the filter piston 26 and filtering receptacle 1 from the compacted ground flavour base and water inside the filtering receptacle as well of its own weight.

1. Filtering receptacle for a solid flavour base, which filtering receptacle is dimensioned to fit inside a pot of a French press, wherein the filtering receptacle has a circumferential central wall part that extends upwards from a bottom wall part and terminates in a free edge of a circumferential upper wall part opposite the bottom wall part, which free edge delimits an opening for adding the solid flavour base to the filtering receptacle, wherein the circumferential upper wall part has a plurality of through-going drain passages, said through-going drain passages are distributed spaced apart along the circumferential upper wall part and are retracted from the free edge, at least some of the through-going drain passages of the circumferential upper wall part extend into an associated channel formed in the exterior face of at least the circumferential central wall part, wherein a channel extend from its through-going drain passage down towards the bottom wall part along the majority of the circumferential central wall part.

2. Filtering receptacle according to claim 1, wherein the channel extends towards the bottom wall part substantially perpendicularly in relation to the free edge, preferably all the through-going drain passages have an associated channel.

3. Filtering receptacle according to claim 1, wherein the bottom wall part has a foot part protruding away from the opening of the filtering receptacle.

4. Filtering receptacle according to claim 1, wherein an interior diameter of the filtering receptacle is larger at the upper wall part than the smallest diameter of circumferential central wall part.

5. Filtering receptacle according to claim 1, wherein an exterior diameter of the filtering receptacle at least at the circumferential upper wall part is selected to be equal to or slightly, smaller than the interior diameter of a pot of a French press inside which the filtering receptacle is to be used, preferably the exterior diameter of the filtering receptacle at least at the circumferential upper wall part is between 0.2% and 5% smaller than the interior diameter of the pot of the French press.

6. Filtering receptacle according to claim 1, wherein the bottom wall part has an inverted centre section, optionally the foot part is at least partly located at and protruding from the inverted centre section.

7. Filtering receptacle according to claim 1, wherein the filtering receptacle is made of a material that expands when subjected to at temperature range between 80° C. and 100° C. and retracts again when cooled below 50° C.

8. Filtering receptacle according to any claim 7, wherein the material is a plastic material, a rubber material, preferably the material is silicone or polypropylene.

9. Filtering receptacle according to claim 1, wherein the solid flavour base is ground coffee or tea leaves.

10. A method of operating the filtering receptacle according to claim 1 in a French press to make a flavoured beverage by, infusion of a solid flavour base, wherein method comprises the steps of
a) placing the filtering receptacle at a bottom of a pot of the French press,
b) adding the solid flavour base to the filtering receptacle before or after step a),
c) adding hot water to the pot,
d) allowing the flavour of the solid flavour base to infuse the hot water,
e) depressing a filter piston of the French press down towards the filtering receptacle to separate the brewed beverage from the solid flavour base,
f) pouring the beverage from the French press while the filter piston remains situated above the filtering receptacle,
g) allowing the filtering receptacle to cool if not already cooled,
h) pressing the filter piston in engagement with the filtering receptacle,
i) retracting the engaged filter piston and filtering receptacle out of the pot, and
j) disengaging the filter piston and filtering receptacle, optionally by rotating and/or a twisting of the filtering receptacle in relation to filter piston,
k) optionally emptying the filtering receptacle and cleaning said filtering receptacle and French press.
